(19) United States
(12) Patent Application Publication
(10) Pub. No.: US 2004/0223827 A1
(43) Pub. Date: Nov. 11, 2004

(54) Stripped thread repair tape and method of use

(76) Inventor: George Alain, Calgary (CA)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/430,541

(22) Filed: May 5, 2003

(51) Int. Cl. F16B 39/02

(52) U.S. Cl. 411/82

(57) ABSTRACT

A threaded hole with damaged threads and a repair apparatus including an elongated, flexible strip material, a portion of the strip material inserted between the threads of the threaded hole and the fastener. The strip material characterized as flowable under compressive stress between the threads of the threaded fastener and the threaded hole, and having substantial rigidity as to engage the fastener within the threaded hole.

### BACKGROUND OF THE INVENTION

INCORPORATION BY REFERENCE: Applicant(s) hereby incorporate herein by reference, any and all U.S. patents, U.S. patent applications, and other documents and printed matter cited or referred to in this application.

### FIELD OF THE INVENTION

This invention relates generally to thread tapes and more particularly to such a tape capable of repairing a stripped machine thread.

### DESCRIPTION OF RELATED ART

The following art defines the present state of this field:

Ahlbrecht et al., U.S. Pat. No. 2,642,416 describes a new compound, the 1,1-dihydroperfluoroalkyl acrylates having the forumula CH₂:CHCOOCH₂CₙF₂ₙ₊₁.

Chesnut et al., U.S. Pat. No. 3,002,770 describes a threaded joint comprising a male fitting having continuous male threads, a female fitting having continuous female threads adapted to mate with the threads on the male fitting, and a preformed transversely stretchable and compressible lubricating and sealing ribbon having a relatively low coefficient of friction and a high degree of lubricity wrapped circumferentially around the threads of the male fitting for at least one turn therearound with the ends of the ribbon overlapped one upon the other by an appreciable amount, said overlapping end portions of the ribbon adhering to one another when pressed into contact by hand, said ribbon prior to turning the male and female fittings together being in the form of a flat coherent unsintered polytetrafluoroethylene film having a specific gravity in the range of about 1.2-1.8 and being about 1 to 20 mils in thickness; the male and female fittings being turned together with the ribbon compressed and conforming substantially with the shape of the space between the male and female threads and defined by said threads when the threads are turned together with the ribbon between them, the ribbon remaining in substantially continuous film form on the faces of the threads between the tips of said threads and providing an antibinding and sealing barrier between the threads and a lubricated surface for turning the fittings with respect to one another at any time during the life of the joint, where by there is provided a joint possessing the following properties: (a) leakproof tightness at low torque, (b) retention of leakproof tightness for the life of the joint, and (c) ease of opening the joint during its life.

Villo, U.S. Pat. No. 3,093,177 describes a self-locking threaded fastener element wherein the self-locking characteristic is derived from a nylon plastic composition having fused juncture with a surface of the thread, said plastic being confined to a local circumferential and axial area of the thread, and being bound to the thread solely by said fused juncture.

Preziosi, U.S. Pat. No. 3,294,139 describes a self locking threaded fastener wherein the thread is of standard form and the self locking characteristic that is derived from a patch of thermoplastic material applied in powder form to a plurality of thread convolutions of the unmodified surfaces of the thread to a limited circumferential extent and fused by heat and solidified without work shaping pressures while the fastener is in a horizontal position, the patch being of the shape of a free form liquid pool of the thermoplastic material adhered to the unmodified surfaces of the thread and gradually merging at its boundary edge portions into such surfaces of the thread.

Coyle, U.S. Pat. No. 3,550,668 describes a self-locking internally threaded fastener having a resiliently deformable insert retained in a sidewall thereof by a rigid outer sleeve.

Faroni, U.S. Pat. No. 3,568,746 describes ABSTRACT: A reusable self locking threaded fastener is provided having a patch of nylon or like thermoplastic material bonded to several convolutions of the unmodified thread surfaces and gradually merging at its boundary edge portions into the thread surfaces, the nylon patch being melted and fused and solidified without work shaping pressures and containing from about 0.1 percent to about 5 percent by weight of molybdenum disulfide a reusable self sealing and self locking fastener is provided in which the unmodified nylon patch has a circumferential extent of about 200° to about 300°; by adding to the nylon patch molybdenum disulfide the circumferential extent may be 360°; a method of forming the selfsealing and self locking fasteners is provided wherein the heated fastener has the nylon in powdered form, and if desired the molybdenum disulfide mixed therein, dropped thereonto while the fastener rotates about its longitudinal axis to melt and hold a quantity of the nylon thereon, after which the fastener may be heated to the fusion temperature of the nylon to further melt the patch further a primer coating of epoxy resin is provided between the patch and the fastener; the resultant fastener can be reused a minimum of five times and still retain the desired self locking and self sealing characteristics thereof.

Duffy, U.S. Pat. No. 3,787,222 describes a method of making a self-locking threaded element, e.g. a screw, including a strongly adhered plastic body or locking patch on its threaded surface where the locking patch is formed with a special configuration for effective locking engagement over a wide range of clearances between the element and mating threaded surfaces, in which method a stream of fine particles of heat softenable resin is directed against a threaded surface portion of a heated metallic element at a temperature lower than that effective to form a continuous convex curved deposit of resin. The threaded portion is kept in the stream of resin particles for a time sufficient to fill the valleys between threads to an extent of at least one-third in areas of the valleys adjacent the central line of the locking patch and to form thin resin deposits in areas spaced from the central line to give in effect an interrupted ridge or bar useful to provide locking action over a wide range of clearances.

Cadwallader, U.S. Pat. No. 4,223,632 describes a self-locking threaded fastener of the type having a resilient thermoplastic resin patch bonded to the thread surface and a method and apparatus for making such fasteners are disclosed. The fastener is heated to a temperature in excess of the plastic melting temperature by induction heating coils and powder is thereupon deposited on the surface of the threads over a predetermined area by gravity feed. Rolling pressure is then applied to the plastic material to form the patch, packing the material between the thread flanks and confining the height of the patch to a controlled radial height above the thread crests. The controlled radial height of the patch is within the normal envelope of the basic major diameter of the fastener thread.

Russum, U.S. Pat. No. 5,813,809 describes a threaded connection between adjoining male/female surfaces is produced by mating a plastic insert embedded in one surface with threads machined on the other surface. The plastic insert is pressed against the machined threads and deformed to provide conforming meshing threads in the insert, thereby producing a threaded engagement between the two surfaces. Preferably, the insert is sufficiently wide to overlap multiple machined threads and yield a stable, strip-resistant engagement. By providing at least three such inserts evenly distributed around the preexisting threads, an axially stable, screwable threaded connection is produced between the two surfaces that does not require precise machining or special tooling for unconventional threads. Although the inserts are preferably used in the female surface for ease of access, they can be used advantageously in equivalent fashion in the male surface of the screwable threaded connection.

Gombos, U.S. Pat. No. 5,909,990 describes a new threadless nut for use with a threaded bolt to form a secure fastener. The inventive device includes a body having opposite first and second faces, and inner and outer side surfaces. The inner side surface of the body defines a bore through the body between the first and second faces of the body. The inner side surface of the body has first and second portions. The diameter of the second portion of the inner side surface is greater than the diameter of the first portion of the inner side surface such that an annular shoulder is formed between the first and second portions of the inner side surface. An annular liner is provided on the second portion of the inner side surface.

Maderek, U.S. Pat. No. 6,034,002 describes a sealing tape which is suitable for winding around pipe ends, especially pipe threads, and for sealing screw pipe joints and spigot pipe joints, which has a waterproof functional layer, preferably with one or more base layers, where the functional layer contains polymers on polyetherester basis, polyurethane basis and/or polyetheramide basis, and the use of the sealing tape in heating pipes, utility water pipes, drinking water pipes, water vapor pipes, gas pipes, compressed air pipes, industrial valves and valves used in domestic installations.

The prior art teaches tape products of various kinds. It also teaches wound plastic tapes for use in sealing the spaces between threads so as to prevent liquid flow, and patches and bulk insert portions for use in securing threaded connections. However, the prior art does not teach a coiled plastic strip of size and resiliency with beneficial use as a filler material in a threaded hole, where the thread of the threaded hole is stripped-out; the plastic strip being inserted into the hole, conforming to the threads of the hole when a mating threaded fastener is engaged therein, the strip forming a shape approximating the stripped-out missing portions in order to create a full strength fastening. The present invention fulfills these needs and provides further related advantages as described in the following summary.

### SUMMARY OF THE INVENTION

The present invention teaches certain benefits in construction and use which give rise to the objectives described below.

A threaded hole with damaged threads and a repair apparatus including an elongated, flexible strip material, a portion of the strip material inserted between the threads of the threaded hole and the fastener. The strip material characterized as flowable under compressive stress between the threads of the threaded fastener and the threaded hole, and having substantial rigidity as to engage the fastener within the threaded hole.

A primary objective of the present invention is to provide an apparatus and method of use of such apparatus that provides advantages not taught by the prior art.

Another objective is to provide such an invention capable of repairing threads of a damaged threaded hole.

A further objective is to provide such an invention capable of reestablishing full threads after such threads have been partially removed from a threaded hole.

A still further objective is to provide such an invention capable of locking a fastener into a threaded hole.

A still further objective is to provide extensions onto threads of a threaded hole that is too large for fully engaging a small threaded fastener.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of one end of the preferred embodiment of the invention;

FIG. 2 is an elevational view thereof showing placement of the invention in a threaded hole;

FIG. 3 is a further elevational view thereof as in FIG. 2 showing engagement of a bolt into the threaded hole; and

FIG. 4 is a perspective view of the invention as provided in a coil form.

### DETAILED DESCRIPTION OF THE INVENTION

The above described drawing figures illustrate the invention in at least one of its preferred embodiments, which is further defined in detail in the following description.

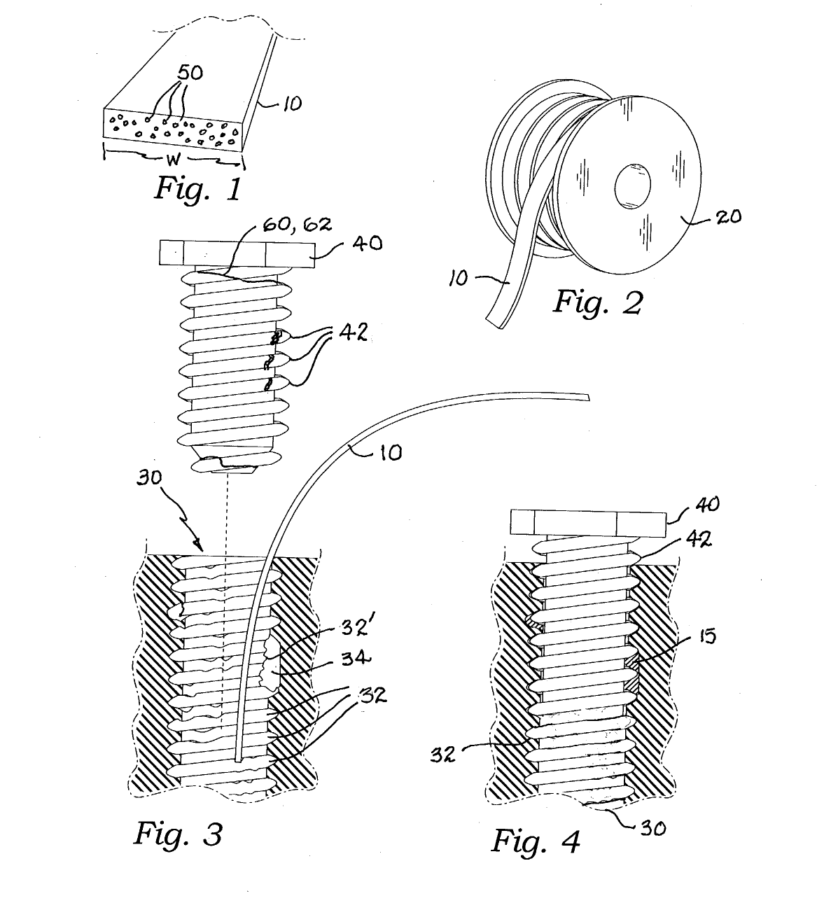

The present invention is a repair apparatus for a damaged threaded hole and a method for using the apparatus to repair the damaged hole. The apparatus is an elongated, flexible strip material 10 as shown in FIG. 1. It is preferably wound on a spool 20 for being dispensed but may be handled in any way desired otherwise. The strip 10 is inserted into the threaded hole 30 which has damaged threads 32 or other damage including pieces missing from the hole itself or from the threads. Another application for the present invention is for preparing a threaded hole that is too large for a threaded fastener, wherein the invention is able to partially or fully correct the large hole to exactly fit the smaller threaded fastener. The flexible strip 10 preferably has a strip width “W” wherein the strip width is less than the diameter of the threaded hole 30 so that the strip 10 is easily inserted into the hole 30. The strip material 10 is characterized as being flowable under compressive stress, and hardenable upon exposure to air after it has been caused to flow under compressive stress. These characteristics are easily obtained. Flow of this material under compression is attained by molding the strip 10 from a polymer that is soft and pliable, as is well known in the art, so that it may be crushed and compressed between the threads 32 of the hole 30 and the threads 42 of the threaded fastener 40. Such characteristics in a polymer is easily obtained and well known in the art and may be a soft polyethylene or other common polymer.

Preferably, the strip material 10 is a combination of a pliable plastic polymer combined homogeneously with a hardenable resin component, where the resin will not harden until a hardener component is mixed into it. Such is well known with epoxy resins and other similar two-part hardening materials. The polymer and resin is mixed and these two components are indistinguishable as they are homogeneously formed. The strip 10 is also filled with microspheres containing a resin hardener 50, whereby, the hardener is disbursed into the strip 10 under the compressive stress experienced when the fastener 40 is engaged with the threaded hole. The strip 10 is upset and tends to flow under this compressive stress. A further result is that the microspheres are broken and disburse their hardener component combining chemically with the resin component to start the curing of the resin which is a slightly exothermic process characterized by hardening. The combining and curing of epoxy resin is well known and results in a very hard and stable material for a high harness on its surface. The strip, when compressed, takes the form of any missing threads or voids 34 in the threaded hole and remains in the threaded hole 30 after the fastener 40 has been removed. This remaining portions are shown in FIG. 4 as numeral 15.

If the fastener 40 remains in the threaded hole 30 the air curing of the resin will take longer but will still occur. The fastener 40 will then be locked into the threaded hole 30 and will not be removable. One preferred method of the invention is to wrap a thread tape 60 such as a Teflon® type of tape about the fastener 40 prior to engaging it with the hole 30, and then withdraw the fastener 40 prior to the resin hardening. The thread tape 60 can then be removed leaving the fastener 40 clean, or in lieu of using a thread tape 60, the fastener 40 can be used without the tape 60 and simply cleaned of the resin prior to the threads 42 of the fastener 40 becoming fouled. A still further method is to use a parting agent such as an oil 62 on the threads 42 of the fastener 40 prior to insertion of the fastener 40 into the hole 40.

When the time necessary to achieve a known level of hardness in the resin is identified, it is possible to withdraw the fastener 40 after the resin has partially “set-up” leaving repaired threads 32′ that will not substantially change their shape during further curing although the fastener 40 is not present, and will thereafter receive the clean fastener 40 in full thread engagement 32 and 42 when curing is completed. Alternatively, the strip 10 may be of such rigidity as to enable immediate removal of the fastener 40 without loosing thread conformation during further curing of the resin component.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A threaded hole repair apparatus comprising: an elongated, flexible strip material for insertion into a threaded hole with damaged threads, the flexible strip having a strip width wherein the strip width is less than a diameter of the threaded hole; the strip material characterized as: (a) flowable under compressive stress, and (b) hardenable upon exposure to air after being caused to flow under compressive stress.

2. The apparatus of claim 1 wherein the strip material is a combination of a pliable plastic polymer combined homogeneously with a resin component, the polymer and resin filled with microspheres containing a resin hardener, whereby, the hardener is disbursed into the combination under the compressive stress, the hardener combining chemically with the resin component to cure the resin characterized by hardening.

3. A threaded hole repair method comprising the steps of: A) providing an elongated, flexible strip material, the strip material characterized as: (a) flowable under compressive stress, and (b) hardenable upon exposure to air after being caused to flow under compressive stress; B) inserting the flexible strip material into a threaded hole having threads wherein at least a portion of the threads are damaged; C) wrapping a corresponding threaded fastener with a thread tape; D) engaging the threaded fastener into the threads of the threaded hole so as to apply a compressive stress to the flexible strip and to cause the flexible strip to flow between the threads of the hole and the threaded fastener and thread voids therein and to cause a resin hardener component within microspheres embedded within the flexible strip to be disbursed and to mix with a resin component of the flexible strip; E) removing the threaded fastener from the threaded hole to expose the mixture of resin and resin hardener to air; and F) reinserting a cleaned threaded fastener into the threaded hole after the mixture of resin and resin hardener in the threaded hole are air cured.

4. The method of claim 4 further comprising the step of wrapping the fastener with a thread tape prior to insertion into the threaded hole.

5. The method of claim 4 further comprising the step of coating the fastener with an parting agent prior to insertion into the threaded hole.

6. A threaded hole and repair apparatus comprising in combination: a threaded hole with damaged threads; a threaded fastener engaging the threads of the threaded hole; and an elongated, flexible strip material, a portion of said strip material inserted between the threads of the threaded hole and the fastener; the strip material characterized as: (a) flowable under compressive stress between the threads of the threaded fastener and the threaded hole, and (b) of substantial rigidity as to engage the fastener within the threaded hole.
